(19) United States
(12) Patent Application Publication
(10) Pub. No.: US 2018/0124337 A1
(43) Pub. Date: May 3, 2018

(54) PIXEL BIASING APPARATUS WITH NOISE CANCELLATION FUNCTION, AND CMOS IMAGE SENSOR INCLUDING THE SAME

(71) Applicant: SK hynix Inc., Icheon-Si (KR)

(72) Inventor: Tae-Hoon Kim, Yongin-si (KR)

(21) Appl. No.: 15/786,379

(22) Filed: Oct. 17, 2017

(30) Foreign Application Priority Data
Nov. 1, 2016 (KR) 10-2016-0144361

(51) Int. Cl. H04N 5/357; H04N 5/225; H04N 5/378; H04N 5/374

(52) U.S. Cl. CPC H04N 5/3575; H04N 5/374; H04N 5/378; H04N 5/225

(57) ABSTRACT

An image sensor device is provided to include: a pixel bias voltage sampling unit suitable for sampling a pixel bias voltage; a pixel power noise addition control unit suitable for controlling the magnitude of added pixel power noise; a pixel power noise addition unit suitable for adding pixel power noise to a node of the pixel bias voltage sampled by the pixel bias voltage sampling unit according to control of the pixel power noise addition control unit; and a biasing unit suitable for offsetting pixel power noise transmitted from the pixel by inverting the pixel power noise added by the pixel power noise addition unit.

### CROSS-REFERENCE TO RELATED APPLICATIONS

This patent document claims priority of Korean Patent Application No. 10-2016-0144361 filed on Nov. 1, 2016, which is incorporated herein by reference in its entirety.

### BACKGROUND

Image sensors can be constructed using photo sensing pixels, e.g., CMOS sensing pixels. It is desirable to reduce the signal noise in processing pixel signals to achieve good quality in the captured images by the sensing pixels.

### SUMMARY

Various embodiments are directed to a pixel biasing apparatus which is capable of canceling pixel power noise transmitted from a pixel while sampling a pixel bias voltage, and a CIS including the same.

Also, various embodiments are directed to a pixel biasing apparatus which is capable of adding pixel power noise to a node of a sampled pixel bias voltage and inverting the added power noise using a capacitor, thereby offsetting pixel power noise transmitted from a pixel, and a CIS including the same.

In an embodiment, a pixel biasing apparatus may include: a pixel bias voltage sampling unit suitable for sampling a pixel bias voltage; a pixel power noise addition control unit suitable for controlling the magnitude of added pixel power noise; a pixel power noise addition unit suitable for adding pixel power noise to a node of the pixel bias voltage sampled by the pixel bias voltage sampling unit according to control of the pixel power noise addition control unit; and a biasing unit suitable for offsetting pixel power noise transmitted from the pixel by inverting the pixel power noise added by the pixel power noise addition unit. In one aspect, an image sensor device is provided to comprise: an image sensing pixel that coverts light into a pixel signal; and a pixel biasing circuit coupled to the image sensing pixel to receive the pixel signal and to supply a bias to the pixel signal to reduce noise in the pixel signal, wherein the pixel biasing circuit includes: a pixel bias voltage sampling unit coupled to the image sensing pixel to sample at a circuit node a pixel bias voltage associated with the image sensing pixel; a pixel power noise addition unit coupled to the circuit node to add pixel power noise to the circuit node; a pixel power noise addition control unit coupled to the pixel power noise additional unit and operable to control a magnitude of added pixel power noise produced by the pixel power noise additional circuit; and a biasing unit coupled to the image sensing pixel to offset pixel power noise transmitted from the image sensing pixel by inverting the pixel power noise added by the pixel power noise addition unit.

In some implementations, the pixel power noise addition unit comprises a variable capacitor which is varied to adjust the magnitude of the pixel power noise according to control of the pixel power noise addition control unit, and adds the pixel power noise to the node of the pixel bias voltage sampled by the pixel bias voltage sampling unit. In some implementations, the variable capacitor receives a pixel supply voltage from the pixel power noise addition control unit or the pixel, or transmits the pixel power noise to the node of the pixel bias voltage at a ratio which is set according to the varied size. In some implementations, the pixel power noise addition control unit controls the magnitude of the added pixel power noise by adjusting the size of the variable capacitor. In some implementations, the pixel power noise addition control unit controls the magnitude of the added pixel power noise by applying a pixel supply voltage to a predetermined number of capacitors among a plurality of capacitors of the variable capacitor. In some implementations, the pixel power noise addition control unit comprises one or more inverters. In some implementations, the pixel power noise addition unit comprises a plurality of capacitors, adjusts the magnitude of the pixel power noise according to control of the pixel power noise addition control unit, and adds the pixel power noise to the node of the pixel bias voltage sampled by the pixel bias voltage sampling unit. In some implementations, the biasing unit is operated to bias a pixel signal, according to the pixel bias voltage sampled by the pixel bias voltage sampling unit and containing the pixel power noise added by the pixel power noise addition unit, and offsets pixel power noise transmitted from the pixel by inverting the pixel power noise added by the pixel power noise addition unit. In some implementations, the pixel bias voltage sampling unit samples a pixel bias voltage from an external pixel bias voltage supply unit, and receives the pixel power noise from the pixel power noise addition unit through the node of the sampled pixel bias voltage.

In an embodiment, an image sensor device may include: a pixel array including optical sensing pixels, each pixel outputting a pixel signal corresponding to incident light; a pixel bias voltage supply unit coupled to supply a pixel bias voltage; a pixel biasing apparatus coupled to the pixel array and operable to add pixel power noise to a node of the pixel bias voltage to offset and canceling the pixel power noise transmitted from the pixel array by inverting the added pixel power noise; and a readout processing unit coupled to the pixel biasing apparatus and the pixel array to read out a pixel signal from a pixel in the pixel array.

In some implementations, the pixel biasing apparatus comprises: a pixel bias voltage sampling unit suitable for sampling the pixel bias voltage; a pixel power noise addition control unit suitable for controlling the magnitude of added pixel power noise; a pixel power noise addition unit suitable for adding pixel power noise to a node of the pixel bias voltage sampled by the pixel bias voltage sampling unit according to control of the pixel power noise addition control unit; and a biasing unit suitable for offsetting pixel power noise transmitted from the pixel array by inverting the pixel power noise added by the pixel power noise addition unit. In some implementations, the pixel power noise addition unit comprises a variable capacitor which is varied to adjust the magnitude of the pixel power noise according to control of the pixel power noise addition control unit, and adds the pixel power noise to the node of the pixel bias voltage sampled by the pixel bias voltage sampling unit. In some implementations, the variable capacitor receives a pixel supply voltage from the pixel power noise addition control unit or the pixel array, or transmits the pixel power noise to the node of the pixel bias voltage at a ratio which is set according to the varied size. In some implementations, the pixel power noise addition control unit controls the magnitude of the added pixel power noise by adjusting the size of the variable capacitor. In some implementations, the pixel power noise addition control unit controls the magnitude of the added pixel power noise by applying a pixel supply voltage to a predetermined number of capacitors among a plurality of capacitors of the variable capacitor. In some implementations, the pixel power noise addition unit comprises a plurality of capacitors, adjusts the magnitude of the pixel power noise according to control of the pixel power noise addition control unit, and adds the pixel power noise to the node of the pixel bias voltage sampled by the pixel bias voltage sampling unit. In some implementations, the biasing unit is operated to bias a pixel signal, according to the pixel bias voltage sampled by the pixel bias voltage sampling unit and containing the pixel power noise added by the pixel power noise addition unit, and offsets pixel power noise transmitted from the pixel array by inverting the pixel power noise added by the pixel power noise addition unit. In some implementations, the pixel bias voltage sampling unit samples the pixel bias voltage supplied from the pixel bias voltage supply unit, and receives the pixel power noise from the pixel power noise addition unit through the node of the sampled pixel bias voltage. In some implementations, the pixel power noise addition control unit controls the pixel power noise addition units installed in the respective columns at the same time. In some implementations, the pixel power noise addition control unit controls one capacitor of the pixel power noise addition unit installed at each column, according to each control bit.

### BRIEF DESCRIPTION OF THE DRAWINGS

FIG. 1 is a circuit diagram of an example of a unit pixel based on an embodiment of the disclosed technology.

FIG. 2 is a diagram illustrating an example of a CIS using a local bias sampling method based on an embodiment of the disclosed technology.

FIG. 3 is a diagram illustrating an example of a CIS using a global bias sampling method based on an embodiment of the disclosed technology.

FIG. 4 is a diagram for describing the transmission mechanism of pixel power noise in an exemplary CIS.

FIG. 5 is a configuration diagram of an example of a pixel biasing apparatus with a noise cancellation function based on an embodiment of the disclosed technology.

FIG. 6 is a diagram illustrating an example of a pixel biasing apparatus using a local bias sampling method based on an embodiment of the disclosed technology.

FIG. 7 is a diagram illustrating an example of a pixel power noise addition control unit based on an embodiment of the disclosed technology.

FIG. 8 is a diagram illustrating an example of a pixel biasing apparatus using a global bias sampling method based on an embodiment of the disclosed technology.

FIG. 9 is a configuration diagram of an example of a CIS based on an embodiment of the disclosed technology.

### DETAILED DESCRIPTION

The disclosed image sensing technology can be implemented to provide a pixel biasing apparatus or circuit in an image sensor device, including, e.g., image sensing devices with CMOS image sensors, to reduce or cancel pixel power noise transmitted from a pixel without additional power consumption.

The disclosed technology can be used to address noise issues in image sensor arrays using a column parallel ADC (Analog-to-Digital Converter) structure. The pixel signals may be simultaneously read out from all pixels located at the same row line, when power noise caused by a pixel supply voltage VDD_PIXEL is applied into the pixels. In this case, random line noise may occur, so that each row line has different pixel power noise. Since the line noise is visually prominent, the line noise should be reduced.

Specifically, the power noise caused by the pixel supply voltage VDD_PIXEL is transmitted at a predetermined ratio to an FD (Floating Diffusion) node in a pixel, and then inputted to a comparator in a readout processing unit through a pixel source follower circuit. The pixel power noise inputted to the comparator is transmitted to an ISP (Image Signal Processor) through the readout processing unit. That is, since the readout processing unit cannot block all frequency bands of noises, a specific band of noise may be transmitted to the ISP, thereby degrading an image quality. This can be achieved by implementing the disclosed technology in this patent document.

Various embodiments will be described below in more detail with reference to the accompanying drawings. The present invention may, however, be embodied in different forms and should not be construed as limited to the embodiments set forth herein. Throughout the disclosure, like reference numerals refer to like parts throughout the various figures and embodiments of the present invention.

Throughout the specification, when one element is referred to as being “connected or coupled to” another element, it may indicate that the former element is directly connected or coupled to the latter element or another element is interposed therebetween. Furthermore, when an element is referred to as “comprising” or “having” a component, it may indicate that the element does not exclude another component but can further comprise another component, unless referred to the contrary. Furthermore, although a component described in the specification is represented in the form of a singular form, the present embodiment is not limited thereto, but the corresponding component may be configured as a plurality of components.

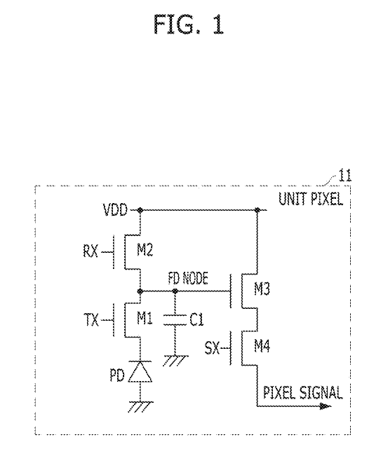

FIG. 1 is a circuit diagram of an example of a unit pixel of an embodiment of the disclosed technology, illustrating a 4-transistor pixel.

Referring to FIG. 1, the unit pixel 11 may include a photodetector PD, a transmission transistor M1 coupled to the photodetector PD to transmit an output from the photodetector PD to a floating diffusion (FD) node, a reset transistor M2 coupled between the transmission transistor M1 and a terminal for receiving a supply voltage VDD, a drive transistor M3 coupled to the FD node and the supply voltage VDD, and a select transistor M4 coupled to the drive transistor M4 for producing a pixel signal.

In operation, the photodetector PD may perform a photoelectric conversion function. That is, the photodetector PD may receive light from outside, and generate a photo charge based on or in response to the received light. The photodetector PD may be turned on or off in response to a control signal outputted from a control unit (not illustrated). When the photodetector PD is turned on, the photodetector PD may sense incident light and generate a photo charge in response to the received light. On the other hand, when the photodetector PD is turned off, the photodetector PD may not sense incident light. The photodetector PD may be implemented by one or more of a photo diode, a photo transistor, a photo gate, a PPD (Pinned Photo Diode) and combinations thereof. As illustrated in FIG. 1, the photodetector PD in that specific example is a two-terminal device having one terminal to a ground and another terminal as an output to the transmission transistor M1.

The transmission transistor M1 may transmit the photo charges received at one terminal of M1 from the photodetector PD to the Floating Diffusion (FD) node coupled to the other terminal of the M1. This transmission operation at M1 can be controlled in response to a transmission control signal TX that is applied to the gate terminal of the M1 to turn on M1 for transmission and to turn off M1 to terminate the transmission.

The reset transistor M2 may transmit the supply voltage VDD applied to one terminal thereof (the drain or source) to the FD node coupled to the other terminal thereof (the source or drain), in response to a reset control signal RX applied to the gate terminal thereof. The reset transistor M2 may reset the photo charge stored in the FD node in response to the reset control signal RX. The supply voltage VDD applied to the drain terminal of the reset transistor M2 may serve as a reset voltage from the viewpoint of the reset transistor M2. In operation, when the reset control signal RX turns off the resent transistor M2, the signal at the FD node reflects the photo charge that is received from the PD and is stored at the FD node. When the reset control signal RX turns on the resent transistor M2, the supply voltage VDD is applied to the FD node through the M2 and thus washes out the signal received from the PD.

In the example in FIG. 1, the drive transistor M3 has one terminal coupled to the supply voltage VDD and other terminal coupled to the select transistor M4. The gate of the drive transistor M3 is coupled to the FD node to generate an electrical signal corresponding to the photo charge stored in the FD node at the terminal coupled to the select transistor M4. In one implementation, for example, the drive transistor M3 may be implemented as a source follower or a buffer amplifier.

The select transistor M4 may be operated in response to a select control signal SX applied to the gate terminal thereof, and output the electrical signal from the drive transistor M3, applied to one terminal thereof, as a pixel signal through the other terminal thereof. In operation, the select transistor M4 may perform a switching operation and address operation for selecting the unit pixel 11 to output a pixel signal in response to the select control signal SX.

The FD node is a diffusion area which commonly constitutes the other terminals of the transmission transistor M1 and the reset transistor M2, and stores a charge corresponding to an image signal or reset voltage. Thus, the FD node may be modeled as a unique capacitor C1 of the FD node with respect to the ground as shown in FIG. 1.

The operations of the unit pixel 11 are further described below.

A reset operation is performed. More specifically, the photodetector PD may be reset during a period in which the transmission control signal TX and the reset control signal RX are enabled. That is, when the transmission control signal TX has a high level, the transmission transistor M1 may be turned on to transmit a photo charge remaining in the photodetector PD to the FD node, and when the reset control signal RX has a high level, the reset transistor M2 may be turned on to reset the photo charge stored in the FD node.

Subsequently, a photoelectric conversion operation is performed. More specifically, the photodetector PD may perform a photoelectric conversion function during an exposure period. That is, the photodetector PD may receive light from outside, and generate a photo charge corresponding to the received light.

Subsequently, a correlated double sampling (CDS) operation is performed. More specifically, during a period in which the select control signal SX is enabled and the reset control signal RX is enabled, the FD node may be reset. That is, after the select transistor M4 is turned on according to the high-level select control signal SX, the reset transistor M2 may be turned on according to the high-level reset control signal RX, and reset the photo charge stored in the FD node at a predetermined cycle for CDS (Correlated Double Sampling).

Subsequently, during a reset signal readout period in which the select control signal SX is enabled, a reset signal may be read out. In this readout operation, the drive transistor M3 generates an electrical signal corresponding to the charge stored in the FD node coupled to the gate terminal thereof, and outputs the generated signal as the reset signal. The charge stored in the FD node may indicate the charge when the FD node is reset.

Subsequently, during a period in which the select control signal SX is enabled and the transmission control signal TX is enabled, a photo charge corresponding to an image signal may be transmitted to the FD node. When the transmission control signal TX has a high level, the transmission transistor M1 may be turned on to transmit the photo charge generated from the photodetector PD to the FD node.

Subsequently, a pixel readout operation is performed. More specifically, during a pixel signal readout period in which the select control signal SX is enabled, a pixel signal may be read out. That is, the drive transistor M3 may generate an electrical signal corresponding to the photo charge stored in the FD node coupled to the gate terminal thereof, and output the generated signal as the pixel signal.

Having explained the basic pixel circuit structure and its operations, the following sections describe a pixel biasing apparatus or circuit in an image sensor device to reduce or cancel pixel power noise while minimizing the power consumption of the image sensor device.

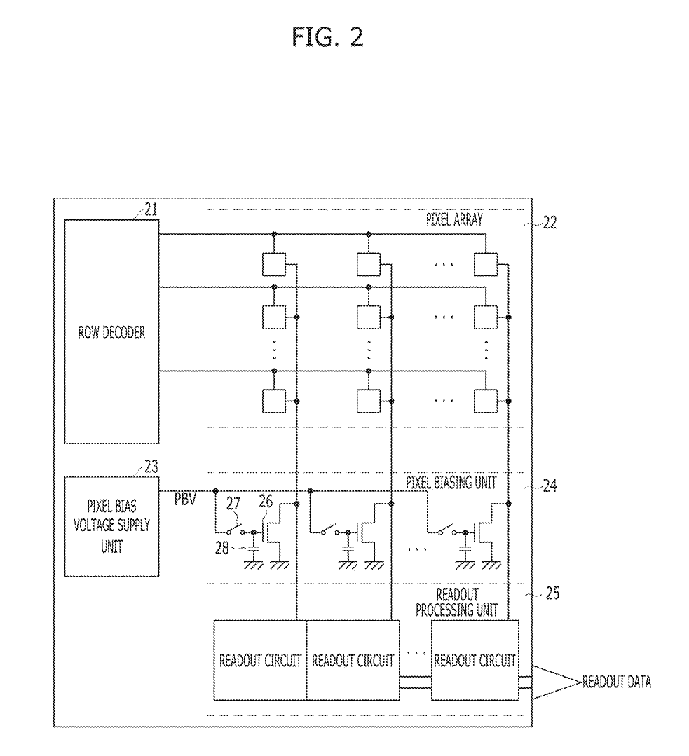

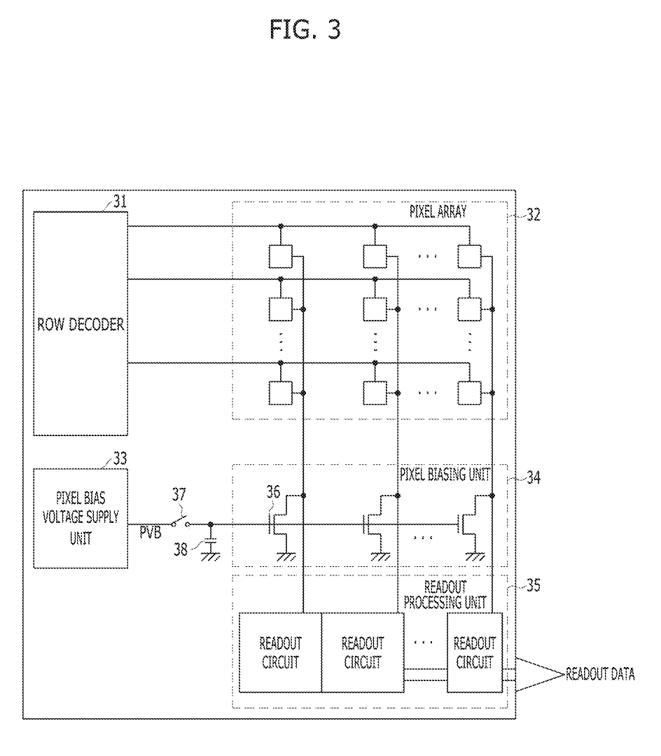

FIG. 2 is a diagram illustrating an example of a CIS having a pixel array of the pixels in FIG. 1 using a local bias sampling method based on an embodiment of the disclosed technology. FIG. 3 is a diagram illustrating an example of a CIS having a pixel array of the pixels in FIG. 1 for using a global bias sampling method based on an embodiment of the disclosed technology.

Referring to FIG. 2 or 3, the CIS illustrated may include a row decoder 21 or 31, a pixel array 22 or 32 of unit pixels as shown in FIG. 1, a pixel bias voltage supply unit 23 or 33, a pixel biasing unit or circuit 24 or 34 and a readout processing unit or circuit 25 or 35.

The row decoder 21 or 31 may select pixels (or unit pixels) for each row line, in order to control the operation of the pixel array 22 or 32.

The pixel array 22 or 32 may include a plurality of pixels with an array structure to sense light, and generate a pixel signal (pixel output signal) at each pixel corresponding to the sensed light of each pixel. Among the pixels included in the pixel array 22 or 32, pixels selected and driven by the row decoder 21 or 31 may output their respective pixel signals. In some implementations, the output pixel signal from a pixel may be an analog pixel signal as an electrical signal, and may include a reset voltage and a signal voltage.

The pixel bias voltage supply unit 23 or 33 may generate a pixel bias voltage PBV, and apply (supply) the generated voltage to a pixel bias transistor 26 or 36 of the pixel biasing unit 24 or 34. The pixel bias transistor 26 or 36 may be referred to as a load transistor.

The pixel biasing unit 24 or 34 may bias the pixel signal from the pixel array 22 or 32 according to the pixel bias voltage PBV from the pixel bias voltage supply unit 23 or 33.

The readout processing unit 25 or 35 may read out the pixel signal biased by the pixel biasing unit 24 or 34, and output the readout data to an ISP (Image Signal Processor). The readout processing unit 25 or 35 may read out the pixel signal (analog signal) by converting the pixel signal into a digital signal. For this operation, the readout processing unit 25 may include a ramp signal generator, a plurality of comparators, a plurality of counters, a plurality of latches, a column address decoder, a sense amplifier and the like.

Since the pixel bias voltage applied to the pixel bias transistor 26 or 36 of the pixel biasing unit 24 or 34 is directly supplied from the pixel bias voltage supply unit 23 or 33, circuit noise generated from the pixel bias voltage supply unit 23 or 33 may be applied together, or external noise from outside the device may be introduced to degrade an image quality.

In order to prevent the image quality degradation caused by the noise, the local bias sampling method using one sampling switch 27 and one sampling capacitor 28 at each column of the pixel biasing unit 24 or the global bias sampling method using one sampling switch 37 and one sampling capacitor 38 for the whole columns may be mainly used as illustrated in FIGS. 2 and 3.

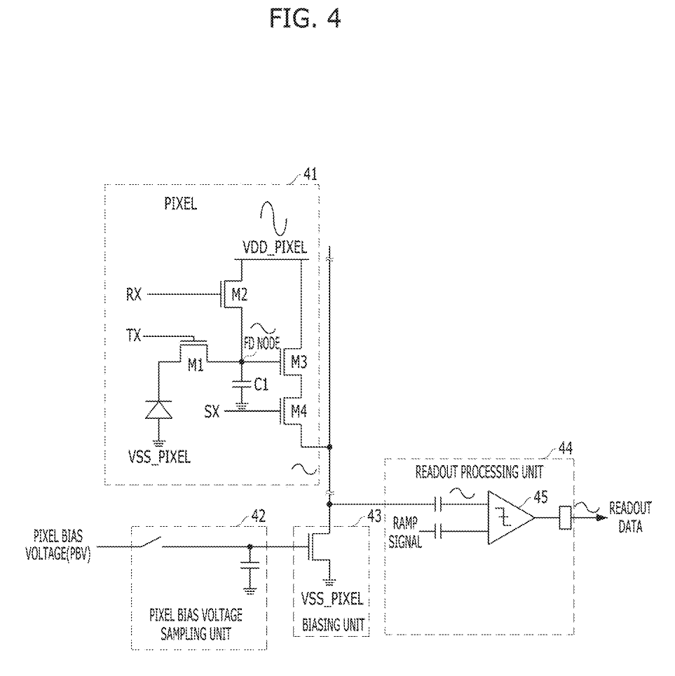

FIG. 4 is a diagram for describing the transmission mechanism of pixel power noise in an example CIS device.

Referring to FIG. 4, the illustrated CIS may include a pixel 41, a pixel bias voltage sampling unit 42, a biasing unit 43 and a readout processing unit 44.

First, the pixel 41 may sense light, and generate a pixel signal (pixel output signal) corresponding to the sensed light.

The pixel bias voltage sampling unit 42 may sample a pixel bias voltage PBV.

The biasing unit 43 may bias the pixel signal from the pixel 41 according to the pixel bias voltage PBV sampled by the pixel bias voltage sampling unit 42.

The readout processing unit 44 may read out the pixel signal biased by the biasing unit 43, and output the readout data to the ISP.

However, when power noise is caused by a supply voltage VDD_PIXEL of the pixel 41, pixel power noise may be transmitted at a predetermined ratio to the FD node according to a capacitor dividing ratio of the pixel 41. The pixel power noise transmitted to the FD node may be inputted to a comparator 45 in the readout processing unit 44 through the pixel source follower circuit, and a predetermined amount of pixel power noise may be transmitted to the ISP according to the BPF (Band Pass Filter) characteristic of the comparator 45, thereby having an influence on an image.

In the above operation, since one row line is simultaneously read out in the column parallel CIS, random row line noise may be outputted with the image, thereby seriously degrading the image.

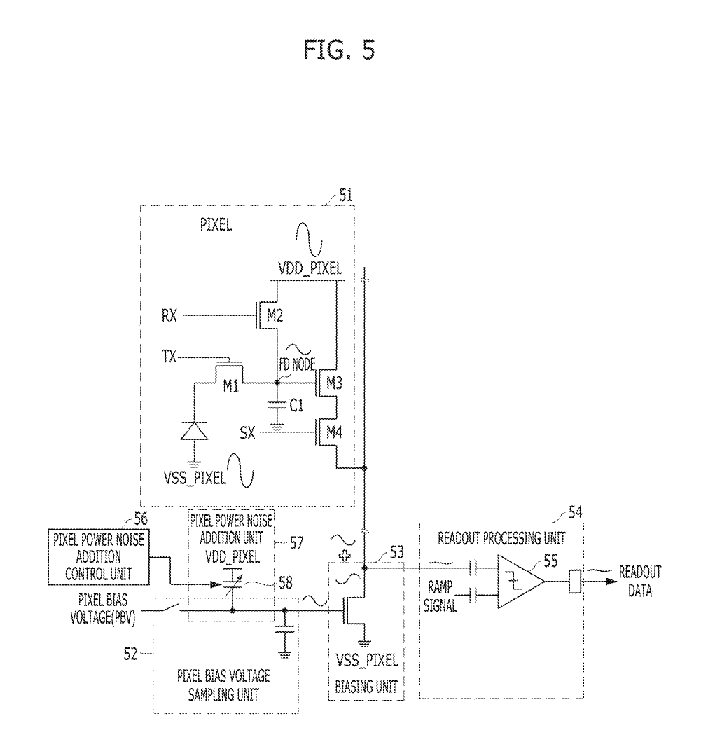

The disclosed technology in this patent document provides a configuration for offsetting and canceling pixel power noise transmitted from a pixel by adding and inverting pixel power noise at the node of a sampled pixel bias voltage, using a capacitor. FIGS. 5 to 8 illustrate examples of implementing the configuration.

FIG. 5 is a configuration diagram of an example of a pixel biasing apparatus with a noise cancellation function based on one embodiment of the disclosed technology.

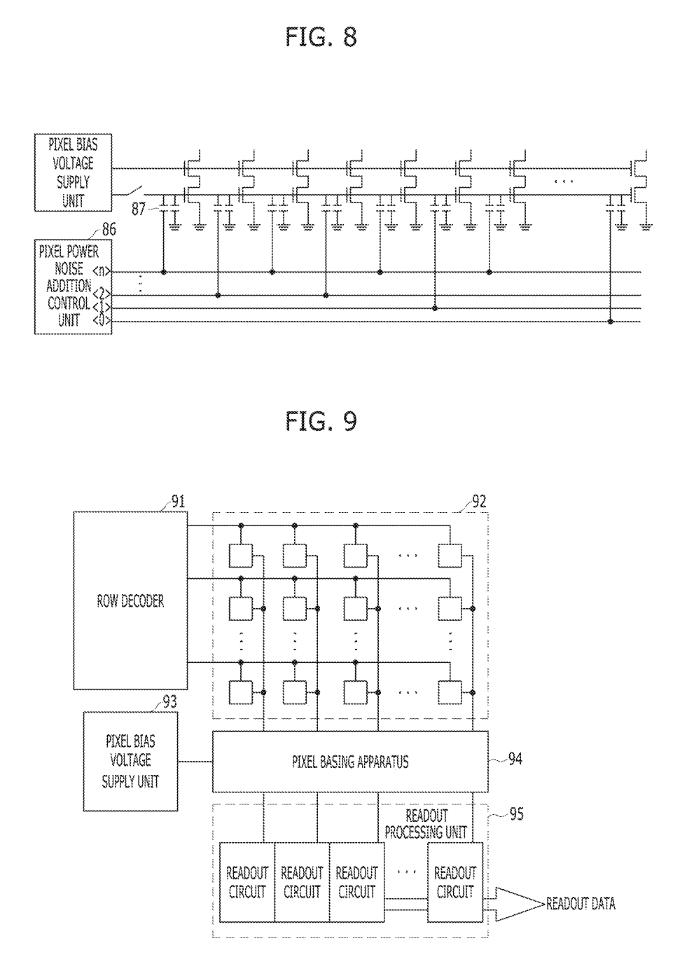

As illustrated in FIG. 5, the pixel biasing apparatus in accordance with the present embodiment may include a pixel bias voltage sampling unit 52, a pixel power noise addition control unit 56, a pixel power noise addition unit 57 and a biasing unit 53. The pixel bias voltage sampling unit 52 may sample a pixel bias voltage PBV, which is applied from a pixel bias voltage supply unit as shown in FIG. 8, using a capacitor. The pixel power noise addition control unit 56 may control the magnitude of added pixel power noise. The pixel power noise addition unit 57 may add the pixel power noise to the node of the pixel bias voltage sampled by the pixel bias voltage sampling unit 52 according to control of the pixel power noise addition control unit 56. The biasing unit 53 may offset pixel power noise transmitted from a pixel 51 by inverting the pixel power noise added by the pixel power noise addition unit 57.

The pixel bias voltage sampling unit 52 may sample the pixel bias voltage PBV from the pixel bias voltage supply unit as shown in FIG. 8, and receive the pixel power noise from the pixel power noise addition unit 57 to the node of the sampled pixel bias voltage. The pixel bias voltage sampling unit 52 may be implemented with one sampling switch and one sampling capacitor. At this time, the node of the sampled pixel bias voltage may be set to a node between the sampling switch and the sampling capacitor, and the sampling switch may be turned on/off according to a control signal from an external control unit (for example, timing generator).

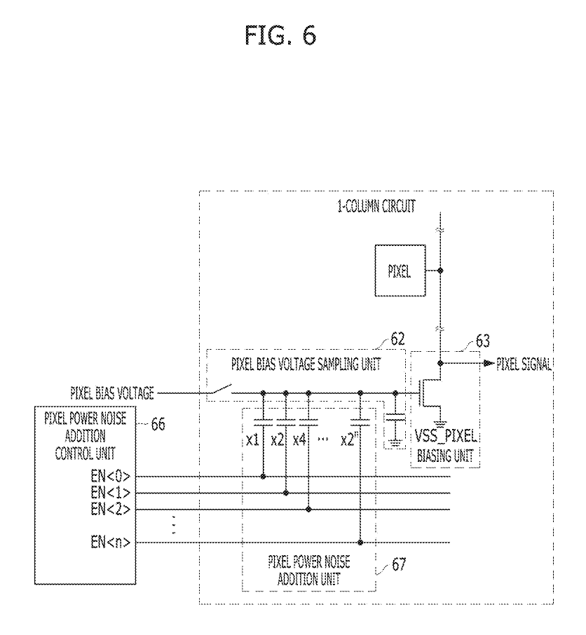

The pixel power noise addition unit 57 may include a variable capacitor 58 which is varied to adjust the magnitude of the pixel power noise according to control of the pixel power noise addition control unit 56, and adds the pixel power noise to the node of the pixel bias voltage sampled by the pixel bias voltage sampling unit 52. One terminal of the variable capacitor 58 may be coupled to the supply voltage VDD_PIXEL of the pixel so as to receive the pixel power noise, and the other terminal of the variable capacitor 58 may be coupled to the node of the pixel bias voltage sampled by the pixel bias voltage sampling unit 52. The variable capacitor 58 may have a capacitance value which is varied according to the control of the pixel power noise addition control unit 56. The variable capacitor 58 may be configured to receive the supply voltage VDD_PIXEL from the pixel power noise addition control unit 56, the pixel 51 or another device. The variable capacitor 58 may be implemented with a string of switches and capacitors, and configured to have a capacitance value which is varied while the switches are turned on/off according to the control of the pixel power noise addition control unit 56, or configured as described later with reference to FIG. 6 or 8.

When the pixel biasing apparatus includes the variable capacitor 58 capable of transmitting pixel power noise to the node of the sampled pixel bias voltage, pixel power noise may be transmitted to the node of the pixel bias voltage at a ratio which is set according to the size of the variable capacitor 58. The magnitude of the transmitted pixel power noise may be controlled by adjusting the size of the variable capacitor 58 through the pixel power noise addition control unit 56.

The pixel power noise addition control unit 56 may control the magnitude of the added pixel power noise by adjusting the size of the variable capacitor 58. The pixel power noise addition control unit 56 may control the magnitude of the added pixel power noise by applying the supply voltage VDD_PIXEL of the pixel to a predetermined number of capacitors among the plurality of capacitors of the variable capacitor 58.

The biasing unit 53 may include a pixel bias transistor which is operated to bias a pixel signal in response to the pixel bias voltage applied through the gate terminal thereof, the pixel bias voltage being sampled by the pixel bias voltage sampling unit 52 and containing the pixel power noise added by the pixel power noise addition unit 57, and offsets the pixel power noise transmitted from the pixel 51 by inverting the pixel power noise added by the pixel power noise addition unit 57 or changing the phase of the pixel power noise by 180 degrees. The pixel bias transistor may include an NMOS transistor having a drain terminal coupled to an output node of the pixel source follower circuit, a gate terminal coupled to the pixel bias voltage sampling unit 52, and a source terminal coupled to a ground voltage VSS_PIXEL of the pixel.

Since the pixel power noise from the pixel 51 is not transmitted to an input terminal of the comparator 55 in the readout processing unit 54, image degradation can be prevented. As such, the pixel biasing apparatus in accordance with the present embodiment may not require additional power consumption in order to remove pixel power noise.

The present embodiment may be differently configured depending on the method for sampling the pixel bias voltage (for example, the local bias sampling method or global bias sampling method).

FIG. 6 is a diagram illustrating a pixel biasing apparatus using the local bias sampling method in accordance with an embodiment. p As illustrated in FIG. 6, a plurality of capacitors corresponding to x1, x2, x4, . . . , x²ⁿ, that is, the pixel power noise addition unit 67 may be positioned at the node of the pixel bias voltage sampled by the pixel bias voltage sampling unit 62, where n is a natural number, and the pixel power noise addition control unit 66 may control the plurality of capacitors. The plurality of capacitors may be implemented with MOS capacitors, MIM (Metal-Insulator-Metal) capacitors or PIP (Poly-Insulator-Poly) capacitors.

That is, the pixel power noise addition unit 67 may include a plurality of capacitors, adjust the magnitude of pixel power noise according to control of the pixel power noise addition control unit 66, and add the pixel power noise to the node of the pixel bias voltage sampled by the pixel bias voltage sampling unit 62.

The pixel power noise addition control unit 66 may be located at a left or right adjacent block, and configured to control the pixel power noise addition unit 67 in the respective columns at the same time. When a specific control signal EN<n> is controlled by an input “high”, the pixel power noise addition control unit 66 may transmit pixel power noise caused by the supply voltage VDD_PIXEL of the pixel to the corresponding capacitor of the pixel power noise addition unit 67, and when the specific control signal EN<n> is controlled by an input “low”, the pixel power noise addition control unit 66 may transmit pixel power noise caused by the ground voltage VSS_PIXEL of the pixel to the corresponding capacitor of the pixel power noise addition unit 67. At this time, when the pixel power noise caused by the supply voltage VDD_PIXEL is transmitted to the corresponding capacitor of the pixel power noise addition unit 67, the pixel power noise may be inverted through the biasing unit 63, and offset the pixel power noise transmitted from the pixel. Therefore, when the capacitor size of the pixel power noise addition unit 67 is properly adjusted according to the amount of pixel power noise transmitted from the pixel, the pixel power noise from the pixel can be completely canceled.

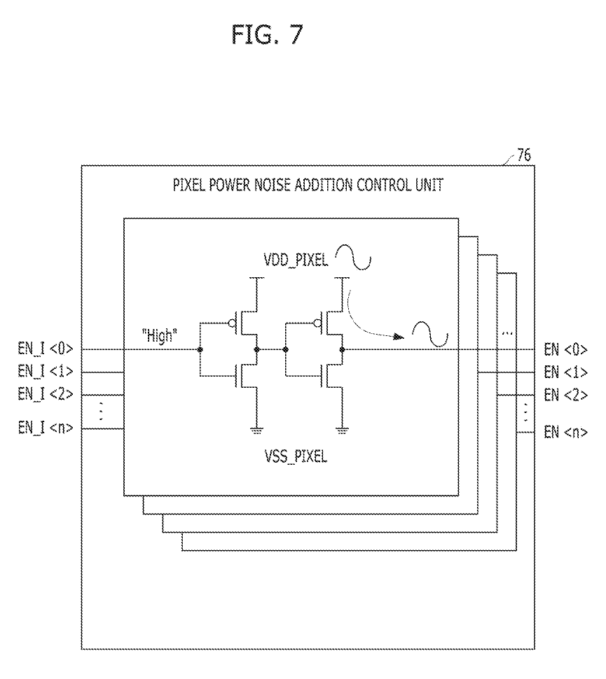

FIG. 7 is a diagram illustrating the pixel power noise addition control unit in accordance with the present embodiment.

The pixel power noise addition control unit 76 in accordance with the present embodiment may include one or more inverters. FIG. 7 illustrates that two inverters are used to implement the pixel power noise addition control unit 76. When an input EN_I<n> is logic “high”, the pixel power noise caused by the supply voltage VDD_PIXEL of the pixel may be transmitted to the corresponding capacitor of the pixel power noise addition unit 67 through a PMOS transistor of the second inverter. On the other hand, when the input EN_I<n> is logic “low”, the pixel power noise caused by the ground voltage VSS_PIXEL of the pixel may be transmitted to the corresponding capacitor of the pixel power noise addition unit 67 through an NMOS transistor of the second inverter. Although the pixel power noise caused by the ground voltage VSS_PIXEL of the pixel is transmitted to the corresponding capacitor of the pixel power noise addition unit 67, the pixel power noise may not be transmitted to the output terminal, because the pixel bias voltage is sampled and the sampling capacitor is present between the node of the pixel bias voltage and the ground voltage VSS_PIXEL of the pixel. Therefore, only the pixel power noise caused by the supply voltage VDD_PIXEL of the pixel may be inverted through the biasing unit 63, and transmitted to the output node of the pixel source follower circuit.

FIG. 8 is a diagram illustrating a pixel biasing apparatus using the global bias sampling method in accordance with an embodiment.

As illustrated in FIG. 8, the pixel biasing apparatus using the global bias sampling method does not need to include a plurality of capacitors positioned for the respective columns. The pixel biasing apparatus may be implemented in the same manner as the local bias sampling method. However, without a plurality of capacitors having different sizes, only one capacitor 87 may be located at each column, and the coupling between the capacitor and the pixel power noise addition control unit 86 at each column may be differently controlled at each control bit. For example, as illustrated in FIG. 8, an n-th bit of the pixel power noise addition control unit 86 may control ½ capacitors among the capacitors of the whole columns, an (n−1)th bit of the pixel power noise addition control unit 86 may control ¼ capacitors among the capacitors of the whole columns, and an (n−2)th bit of the pixel power noise addition control unit 86 may control ⅛ capacitors among the capacitors of the whole columns. In this way, the number of control bits may be increased to more precisely control the capacitors.

FIG. 9 is a configuration diagram of a CIS in accordance with an embodiment.

As illustrated in FIG. 9, the CIS in accordance with the present embodiment may include a row decoder 91, a pixel array 92, a pixel bias voltage supply unit 93, a pixel biasing apparatus 94 and a readout processing unit 95.

The row decoder 91 may be configured to select a pixel for each row line and control the operation of the pixel array 92.

The pixel array 92 may include a plurality of pixels with an array structure to sense light, and generate a pixel signal (pixel output signal) corresponding to the sensed light. Among the pixels included in the pixel array 92, a pixel selected and driven by the row decoder 91 may output a pixel signal. The output pixel signal is an analog pixel signal as an electrical signal, and may include a reset voltage and a signal voltage.

The pixel bias voltage supply unit 93 may generate a pixel bias voltage PBV and apply the generated voltage to the pixel biasing apparatus 94.

The pixel biasing apparatus 94 may add pixel power noise to the node of the pixel bias voltage, and offset and cancel pixel power noise transmitted from the pixel array 92 by inverting the added pixel power noise.

The readout processing unit 95 may read out the pixel signal from the pixel biasing apparatus 94, and output the readout data to an ISP. The readout processing unit 95 may read out the pixel signal (analog signal) by converting the pixel signal into a digital signal. For this operation, the readout processing unit 95 may include a ramp signal generator, a plurality of comparators, a plurality of counters, a plurality of latches, a column address decoder, a sense amplifier and the like.

In accordance with the present embodiments, the pixel biasing apparatus and the CIS including the same can effectively cancel pixel power noise transmitted from a pixel without additional power consumption by sampling a pixel bias voltage applied to a pixel source follower circuit.

Furthermore, the pixel biasing apparatus and the CIS including the same can prevent an image degradation by effectively canceling pixel power noise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve described results. Moreover, the separation of various system components in the embodiments described in this patent document should not be understood as requiring such separation in all embodiments. Only a few implementations and examples are described. Other implementations, enhancements and variations can be made based on what is described and illustrated in this patent document.

What is claimed is:

1. An image sensor device, comprising:
an image sensing pixel that coverts light into a pixel signal; and
a pixel biasing circuit coupled to the image sensing pixel to receive the pixel signal and to supply a bias to the pixel signal to reduce noise in the pixel signal, wherein the pixel biasing circuit includes:
a pixel bias voltage sampling unit coupled to the image sensing pixel to sample at a circuit node a pixel bias voltage associated with the image sensing pixel;
a pixel power noise addition unit coupled to the circuit node to add pixel power noise to the circuit node;
a pixel power noise addition control unit coupled to the pixel power noise additional unit and operable to control a magnitude of added pixel power noise produced by the pixel power noise additional circuit; and
a biasing unit coupled to the image sensing pixel to offset pixel power noise transmitted from the image sensing pixel by inverting the pixel power noise added by the pixel power noise addition unit.

2. The image sensor device of claim 1, wherein the pixel power noise addition unit comprises a variable capacitor which is varied to adjust the magnitude of the pixel power noise according to control of the pixel power noise addition control unit, and adds the pixel power noise to the node of the pixel bias voltage sampled by the pixel bias voltage sampling unit.

3. The image sensor device of claim 2, wherein the variable capacitor receives a pixel supply voltage from the pixel power noise addition control unit or the pixel, or transmits the pixel power noise to the node of the pixel bias voltage at a ratio which is set according to the varied size.

4. The image sensor device of claim 2, wherein the pixel power noise addition control unit controls the magnitude of the added pixel power noise by adjusting the size of the variable capacitor.

5. The image sensor device of claim 2, wherein the pixel power noise addition control unit controls the magnitude of the added pixel power noise by applying a pixel supply voltage to a predetermined number of capacitors among a plurality of capacitors of the variable capacitor.

6. The image sensor device of claim 1, wherein the pixel power noise addition control unit comprises one or more inverters.

7. The image sensor device of claim 1, wherein the pixel power noise addition unit comprises a plurality of capacitors, adjusts the magnitude of the pixel power noise according to control of the pixel power noise addition control unit, and adds the pixel power noise to the node of the pixel bias voltage sampled by the pixel bias voltage sampling unit.

8. The image sensor device of claim 1, wherein the biasing unit is operated to bias a pixel signal, according to the pixel bias voltage sampled by the pixel bias voltage sampling unit and containing the pixel power noise added by the pixel power noise addition unit, and offsets pixel power noise transmitted from the pixel by inverting the pixel power noise added by the pixel power noise addition unit.

9. The image sensor device of claim 1, wherein the pixel bias voltage sampling unit samples a pixel bias voltage from an external pixel bias voltage supply unit, and receives the pixel power noise from the pixel power noise addition unit through the node of the sampled pixel bias voltage.

10. An image sensor device comprising:
a pixel array including optical sensing pixels, each pixel outputting a pixel signal corresponding to incident light at the pixel;
a pixel bias voltage supply unit coupled to supply a pixel bias voltage;
a pixel biasing apparatus coupled to the pixel array and operable to add pixel power noise to a node of the pixel bias voltage, to offset the pixel power noise transmitted from the pixel array by inverting the added pixel power noise; and
a readout processing unit coupled to the pixel biasing apparatus and the pixel array to read out a pixel signal from a pixel in the pixel array.

11. The image sensor device of claim 10, wherein the pixel biasing apparatus comprises:
a pixel bias voltage sampling unit suitable for sampling the pixel bias voltage;
a pixel power noise addition control unit suitable for controlling the magnitude of added pixel power noise;
a pixel power noise addition unit suitable for adding pixel power noise to a node of the pixel bias voltage sampled by the pixel bias voltage sampling unit according to control of the pixel power noise addition control unit; and
a biasing unit suitable for offsetting pixel power noise transmitted from the pixel array by inverting the pixel power noise added by the pixel power noise addition unit.

12. The image sensor device of claim 11, wherein the pixel power noise addition unit comprises a variable capacitor which is varied to adjust the magnitude of the pixel power noise according to control of the pixel power noise addition control unit, and adds the pixel power noise to the node of the pixel bias voltage sampled by the pixel bias voltage sampling unit.

13. The image sensor device of claim 12, wherein the variable capacitor receives a pixel supply voltage from the pixel power noise addition control unit or the pixel array, or transmits the pixel power noise to the node of the pixel bias voltage at a ratio which is set according to the varied size.

14. The image sensor device of claim 12, wherein the pixel power noise addition control unit controls the magnitude of the added pixel power noise by adjusting the size of the variable capacitor.

15. The image sensor device of claim 12, wherein the pixel power noise addition control unit controls the magnitude of the added pixel power noise by applying a pixel supply voltage to a predetermined number of capacitors among a plurality of capacitors of the variable capacitor.

16. The image sensor device of claim 11, wherein the pixel power noise addition unit comprises a plurality of capacitors, adjusts the magnitude of the pixel power noise according to control of the pixel power noise addition control unit, and adds the pixel power noise to the node of the pixel bias voltage sampled by the pixel bias voltage sampling unit.

17. The image sensor device of claim 11, wherein the biasing unit is operated to bias a pixel signal, according to the pixel bias voltage sampled by the pixel bias voltage sampling unit and containing the pixel power noise added by the pixel power noise addition unit, and offsets pixel power noise transmitted from the pixel array by inverting the pixel power noise added by the pixel power noise addition unit.

18. The image sensor device of claim 11, wherein the pixel bias voltage sampling unit samples the pixel bias voltage supplied from the pixel bias voltage supply unit, and receives the pixel power noise from the pixel power noise addition unit through the node of the sampled pixel bias voltage.

19. The image sensor device of claim 11, wherein the pixel power noise addition control unit controls the pixel power noise addition units installed in the respective columns at the same time.

20. The image sensor device of claim 11, wherein the pixel power noise addition control unit controls one capacitor of the pixel power noise addition unit installed at each column, according to each control bit.
